(19) United States
(12) Patent Application Publication
(10) Pub. No.: US 2004/0044954 A1
(43) Pub. Date: Mar. 4, 2004

(54) Data-bidirectional spreadsheet

(76) Inventor: Michael E. Hosea, Wylie, TX (US)

Correspondence Address: TEXAS INSTRUMENTS INCORPORATED, P O BOX 655474, M/S 3999, DALLAS, TX, 75265

(21) Appl. No.: 10/230,854

(22) Filed: Aug. 29, 2002

(51) Int. Cl. G06F 15/00

(52) U.S. Cl. 715/503

(57) ABSTRACT

A spreadsheet software application that is integrated into a calculation environment, such that it is capable both of referencing prior definitions and results in the calculation environment and providing new definitions and results available for use in that environment outside the spreadsheet. Embodiments of the invention include the spreadsheet embedded in a compound document or in an application-based calculation environment on a computer display.

### TECHNICAL FIELD OF THE INVENTION

This invention relates to electronic computing devices and software on those devices, and more particularly to a spreadsheet software application that is integrated into an interactive calculation environment such that it is capable both of referencing prior definitions and results in the calculation environment and providing new definitions and results available for use in that environment outside the spreadsheet.

### BACKGROUND OF THE INVENTION

Spreadsheets have been used in conjunction with other documents such as a word processing document in the prior art. For example, U.S. Pat. No. 5,710,928 describes a word processing process linked to a spreadsheet process. This technique is used in Microsoft Incorporated's popular word processing application “Microsoft Word™.” Document processing systems such as this allow a user to prepare compound documents. A compound document is a document that contains information in various formats. For example, it may contain data in text format, charts, graphs, mathematical or other numeric data. FIG. 1 shows a compound document 101 that contains text data 102 and 103 and spreadsheet data 104.

In another prior art application program called “Maple”™, a spreadsheet is used in a calculation environment on a screen 200 of a computer as shown in FIG. 2. The spreadsheet is shown within the history display of the calculator. In this application variables that are defined in the calculator screen prior to the spreadsheet can be used in the spreadsheet and reflect the value assigned outside the spreadsheet. For example, the variables a and b are defined 202 and then displayed 204 in the calculation environment screen 200. The variables can then be used inside the spreadsheet 206. However, spreadsheet data cannot be used subsequently in the calculator.

In a further prior art application program called “TI Interactive”™, a spreadsheet is also used in a calculation environment on a computer screen. In this application spreadsheet data can be used in the calculator environment by the mathematical system, but there is no way to provide variable definitions to the spreadsheet from outside the spreadsheet.

### SUMMARY OF THE INVENTION

The present invention provides a spreadsheet software application that is capable both of referencing prior definitions and results in the calculation environment and providing new definitions and results available for use in that environment outside the spreadsheet.

An embodiment of the present invention is an application program on a handheld calculator or other computer. The user can define variables and data that are then available for use in a subsequent spreadsheet and also use data from the spreadsheet outside and subsequent to the spreadsheet. The software will determine when to update any data when variables are changed.

Other embodiments of the invention are directed to a compound document that contains a spreadsheet having the features described above. In one such embodiment the spreadsheet uses the same mathematical engine for calculation and data management as other objects in the compound document. In another compound-document embodiment the spreadsheet uses its own internal mathematical engine for calculation and data storage, but it is linked to the external mathematical engine by functions. These are used by each engine to retrieve data from the other.

### BRIEF DESCRIPTION OF THE DRAWINGS

FIG. 1 illustrates a compound document according to the prior art.

FIG. 2 illustrates a compound document according to the prior art which allows a previously defined variable to be used in a spreadsheet.

FIG. 3 illustrates the screen display of on a handheld device according to the present invention.

FIG. 4 illustrates an application based embodiment of the present invention.

FIG. 5 illustrates a compound document embodiment of the present invention.

FIG. 6 illustrates another compound document embodiment of the present invention.

FIG. 7 illustrates a computer device incorporating the features of an embodiment of the present invention.

### DETAILED DESCRIPTION OF THE INVENTION

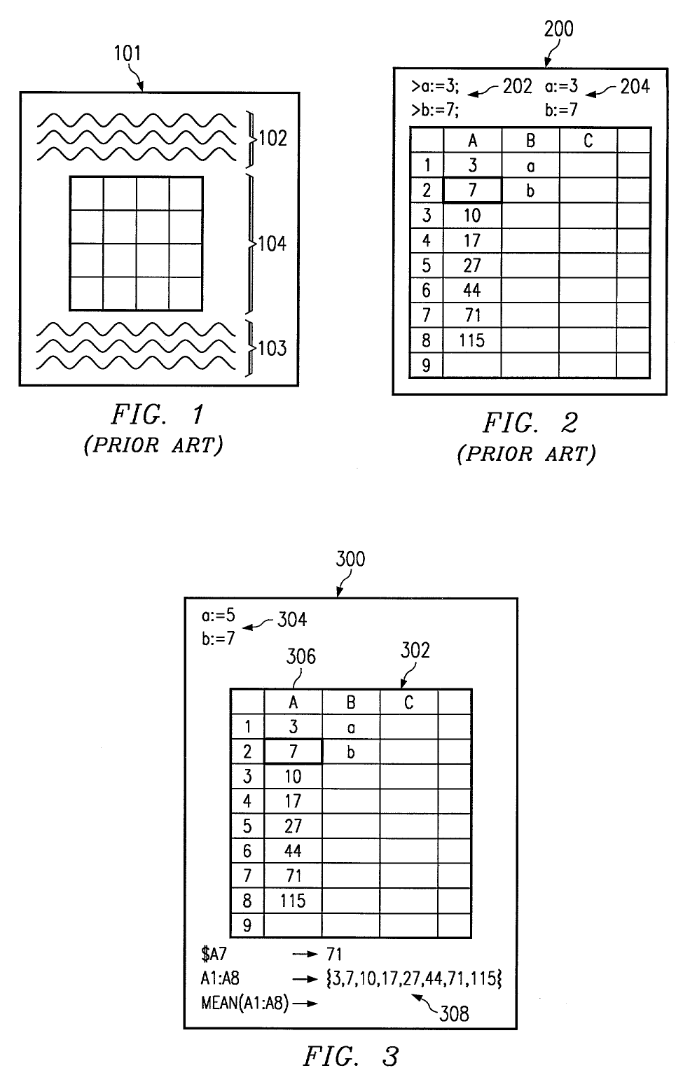

FIG. 3 shows an embodiment of the present invention, which is also used as a general case for other more specific embodiments described below. FIG. 3 illustrates the display area 300 of a display screen on a calculator, computer or hand held computing device that incorporates the features of the present invention. A spreadsheet 302 is shown within the history display or document on the display screen 300. In the embodiment of the present invention, variables that are defined in the screen prior to the spreadsheet can be used in the spreadsheet and reflect the value assigned outside the spreadsheet, and values defined and used in the spreadsheet can be used in the display screen subsequent to the spreadsheet. For example, the variables “a” and “b” are defined in history display or document on the display screen 300 prior to the spreadsheet 302. The variables can then be used inside the spreadsheet 302. Similarly, the spreadsheet defines a column of numbers in column “A”. Reference to cells or variables defined in the spreadsheet can be accessed outside the spreadsheet as shown at 308. The spreadsheet 302 can be fully integrated with the math engine that is operating outside the spreadsheet in the calculation environment 304 portion of the display area, or it can be a separately linked and embedded as described below.

Application Based Embodiment

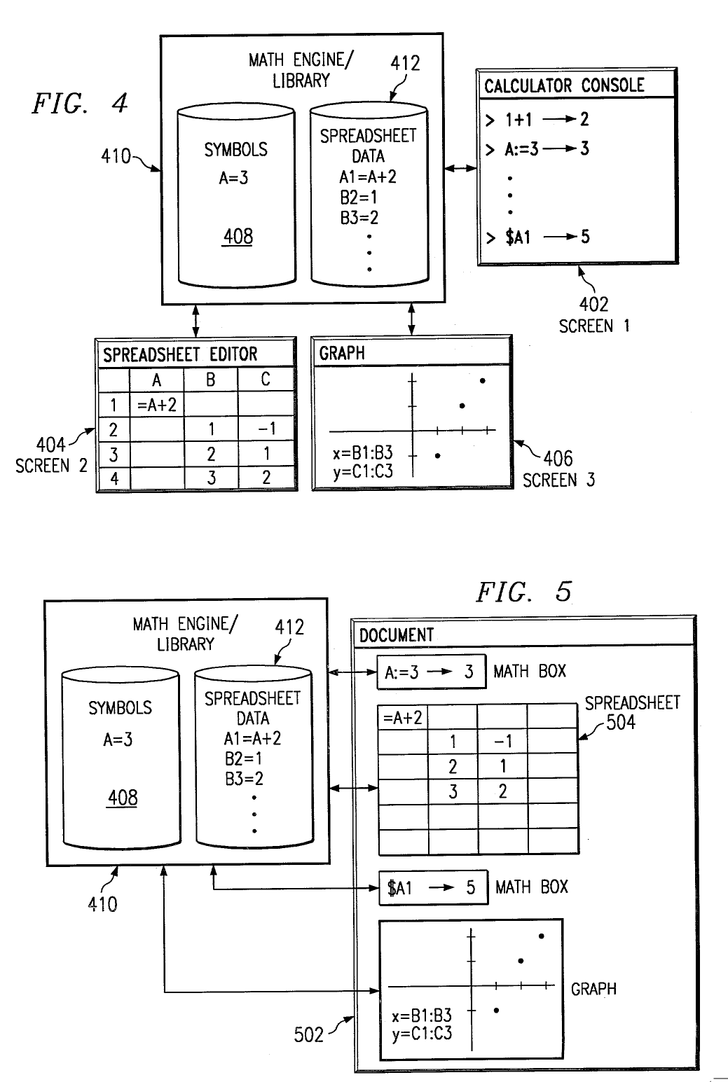

In another embodiment of the present invention shown in FIG. 4, an application-based computing environment contains a spreadsheet that incorporates the features described above with reference to the display 300 shown in FIG. 3. An application-based calculation environment is an integrated set of applications or views that provide different ways of viewing, manipulating, or computing data. In this embodiment, the display 300 having the application-based calculation environment may be on a personal computer or handheld computing device. In this embodiment, the display containing the spreadsheet may or may not be associated with a single document.

In the application-based calculation environment embodiment, the spreadsheet and other portions of the software output may appear as separate display screens as shown in FIG. 4. This embodiment is particularly advantages for a calculator or other hand held device with a limited display size. In this embodiment, a calculator screen 402 allows the user to perform mathematical operations including defining variable A=3. Similarly, a spreadsheet screen 404 allows the user to perform basic spreadsheet functions on a handheld. Results may be displayed on another screen such as a graph 406. In the illustrated example, the spreadsheet defines a cell A1 to be equal to the variable A+2. The calculator screen 402 then can evaluate cell A1 as A+2 (or 3+2) equal to 5 as shown in the calculator screen 402.

In the application-based calculation environment embodiment illustrated in FIG. 4, the math engine/library are integrated for all the applications of the different screens (other variations of this embodiments described below have a separate math engine related to the spreadsheet). Therefore, symbols defined for the calculator console 408 are held in a common library 410 with the spreadsheet data 412.

Calculator History display Embodiment

In another embodiment of the present invention, the display area 300 shown in FIG. 3 represents a heterogeneous calculator history display that contains a spreadsheet having the features described above. This embodiment would is similar to the application program called “Maple”™ described above and as shown in FIG. 2, but incorporating the spreadsheet features described in FIG. 3. In this embodiment, a spreadsheet having the characteristics described above may appear inserted into the history display of a calculator. Variables defined in the spreadsheet are accessable to the calculator command line outside the spreadsheet. If the contents of the history display, including the spreadsheet are saved as a file, then the resulting file is covered by the compound document embodiment described below.

Compound Document Embodiment

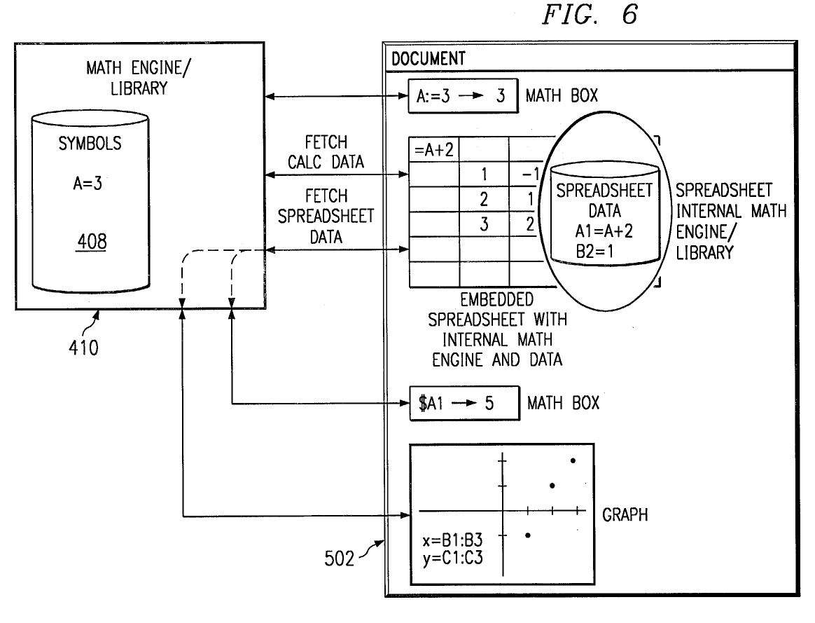

In another embodiment of the present invention, the display area 300 shown in FIG. 5 represents a compound document 502 with an integrated spreadsheet 504 having the features described above with reference to FIG. 3. In this embodiment, the spreadsheet's data will be stored, managed, and manipulated through an API (application program interface) provided by the calculation system to the spreadsheet application, rather than have a separate, self-contained spreadsheet application. The spreadsheet application accesses functions to modify cell values and formulas, recalculate, move, copy, insert, delete cells and ranges, etc. by making function calls into this API. The computational core of the spreadsheet is implemented as a service in the calculation system and not in the spreadsheet application. This design facilitates the sharing of code for parsing and evaluating user inputs.

Each of the three previous embodiments were described with the presumption that they have an integrated spreadsheet with the remaining environment. In these embodiments, the spreadsheet's data is stored, managed, and manipulated through an API provided by the calculation system to the spreadsheet application, rather than have a separate, self-contained spreadsheet application. The spreadsheet application accesses functions to modify cell values and formulas, recalculate, move, copy, insert, delete cells and ranges, etc. by making function calls into this API. The computational core of the spreadsheet is implemented as a service in the calculation system and not in the spreadsheet application. This design facilitates the sharing of code for parsing and evaluating user inputs, though there must be some additional code to support differences in behavior, such as A1 being a cell reference in the spreadsheet environment and being an ordinary variable name outside the spreadsheet environment. Outside the spreadsheet environment the operator ‘$’ can be used to distinguish cell references from ordinary variables, e.g. “$A1” to reference cell A1. Ranges can be indicated with the operator ‘:’, e.g. “A1:B2” references a 2 row, 2 column range. A range may become a list or matrix to the calculation environment when used in an expression, depending on dimensions.

Embodiments with a Separate Spreadsheet Math Engine

In the above embodiments, the spread sheet used a common math engine with the other portions of the computing environment. In each of these cases another embodiment is contemplated where the spreadsheet has its own internal mathematical engine, which is separate from the mathematical engine of the computing environment or compound document in which the spread sheet resides. This variation is illustrated for the embodiment of the compound document with an embedded spreadsheet as shown in FIG. 6. In this embodiment, both the external mathematical engine and spreadsheet application are provided with functions defined for the purpose of retrieving external data, usually a floating point number but possibly a string, given an identifier, e.g. A1 or a. These functions are called external data functions. If such a function is not provided to the spreadsheet or external mathematical engine, then each behaves as if the other did not exist. However, if these functions are provided, then the two components are linked, and it is a simple matter for the spreadsheet application to request data from the external mathematical engine if an unknown identifier is encountered. For example, if the cell formula for cell A1 were “=a+1”, then the spreadsheet would call the external data function provided to it to obtain a value for a. Likewise, if a cell reference, e.g. $A1, is encountered by the external math engine, then it can call its external data function to request a value for A1 from the spreadsheet.

Since a spreadsheet must recalculate its cells in an appropriate order, formulas depending on constant cells first, then formulas depending on these formulas and so forth, it is essential that it be able to examine each cell formula and determine which cells are referenced by the formula since these cells must be calculated before the one being examined. This procedure of determining an appropriate order of cell calculation is known as topological sorting, and it poses some additional difficulties in a symbolic environment if cells can be referenced outside the spreadsheet. For example, if a variable a is defined as the sum of spreadsheet cells A1 and B2, then the dependencies of a cell formula “=B3+a” are not apparent on the surface. This can be handled at some expense by recursively examining the symbolic references stored in each variable. Another solution is for spreadsheet references to resolve immediately to their current values when referenced outside the spreadsheet environment. So, if a=A1+B2, then the variable a contains the result of A1+B2 at the time the assignment is made rather than symbolic references to these cells to be resolved later.

An issue for spreadsheets is when to recalculate. For a stand-alone spreadsheet application, this is not particularly difficult since all interactions are monitored in the context of how they affect the spreadsheet. For a spreadsheet integrated into a computing environment, whether compound document or application-based, there are more considerations. Generally it would be undesirable to recalculate the spreadsheet data each time a variable is modified on the off chance that it might be referenced somewhere inside the spreadsheet. In an embodiment of the present invention, spreadsheet variables accessed during a spreadsheet calculation are monitored and a recalculation is initiated only if one of these specific variables is modified. Each of the symbols in the regular symbol table of the mathematical engine has a flag bit associated with it that is used to track access during spreadsheet recalculation. Before recalculating the spreadsheet, these bits are cleared for all symbols in the regular symbol table of the mathematical engine, i.e., for all the variables already defined. When a symbol is referenced during the recalculation of the spreadsheet, its bit is turned on. When the recalculation is finished, then, only those symbols actually used in the spreadsheet will have their bits turned on. For example, suppose variable a has its bit turned on and variable b does not. Subsequent to the spreadsheet, if the value of b is altered or the variable c is created, it is not necessary to recalculate the spreadsheet since nothing will change. This is known because their flag bits are turned off. If the value of a is altered, however, then the spreadsheet must be recalculated to bring the spreadsheet up-to-date. In the embodiment with a spreadsheet having its own internal mathematical engine, another function can be provided to inform the external mathematical engine when spreadsheet recalculation begins and ends.

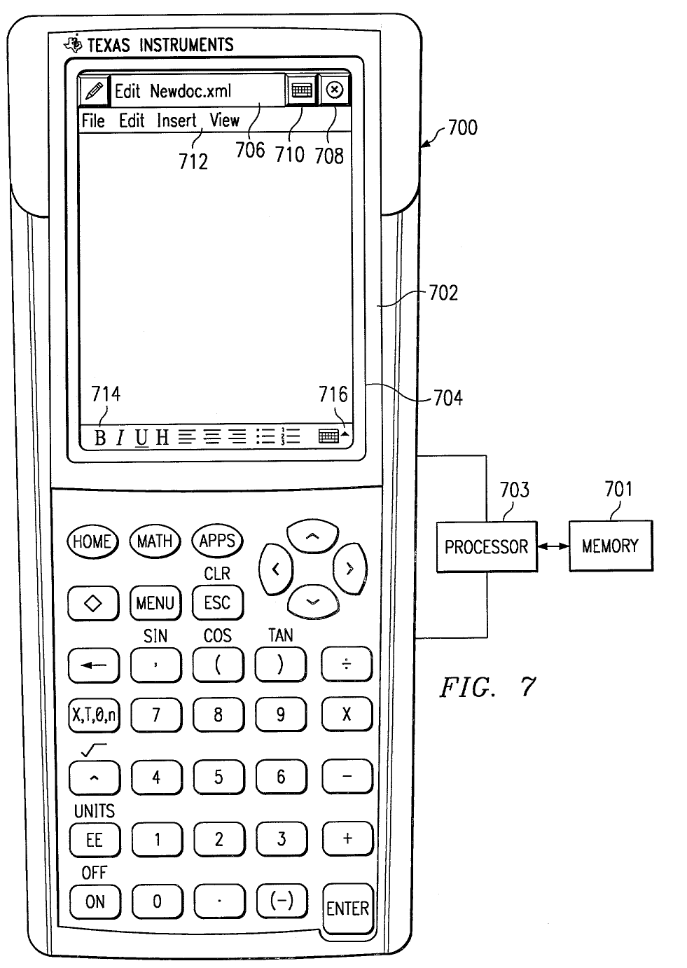

FIG. 7 illustrates a computer or hand held computing device 700 that incorporates features of the present invention. The device executes software described herein stored in memory 701 on the processor 703. The device has a display screen 702 having a display area 704. In this embodiment, the display is a touch sensitive display that uses a stylus for input (not shown).

The display includes a header bar 706 that shows the current tool (in this case a compound document editor tool called “Edit”). The file name of the current open document on the display is also shown on the header bar (“newdoc”). In addition, the header bar shows an icon for closing the tool 708 and a keyboard icon 710 to bring up a “QWERTY” keyboard on the display for input of characters with the stylus. The display area 704 further includes a top button bar 712 that has drop down menus for file, edit, insert and view functions. The display area 704 also has a bottom button bar 714 that has text formatting options, a keyboard button, and an icon 716 to pop-up another menu for inserting text symbols.

Other Embodiments

Although the present invention has been described in detail, it should be understood that various changes, substitutions, and alterations could be made hereto without departing from the spirit and scope of the invention as defined by the appended claims.

The features that are the subject of the present invention could be incorporated into other into other computer based teaching tools and computers. Similarly, other embodiments include the same user interface functionality in a ROM software application package that is executed on a computer, graphing calculator or other handheld device.

What is claimed is:

1. A software program stored on a computer media for a computer device which provides a user interface comprising:
a display area;
a spreadsheet area inside the display area, and
wherein definitions and results defined in the display area outside the spreadsheet area are available in the spreadsheet, and the spread sheet provides definitions and results defined in the spreadsheet to the display area outside and subsequent to the spreadsheet.

2. The software program of claim 1, wherein the spreadsheet area is a fully functional spreadsheet such that when a cursor is placed in the spreadsheet area, the full features of the spreadsheet are functional.

3. The software program of claim 1, further comprising application-based calculation environment wherein the spreadsheet and other portions of the software output appear as separate display screens.

4. The software program of claim 3, wherein the application-based calculation environment embodiment is on a handheld calculator.

5. The software program of claim 1, wherein the display area is a computing display area of a calculation environment.

6. The software program claim 1, wherein the display area is part of a compound document which incorporates the spreadsheet and wherein the definitions and results outside the spreadsheet comprise math boxes and graphically displayed data.

7. The software program of claim 3, wherein the spreadsheet incorporates a separate math engine and library.

8. The software program of claim 5, wherein the spreadsheet incorporates a separate math engine and library.

9. The software program of claim 6, wherein the spreadsheet incorporates a separate math engine and library.

10. A handheld computing device comprising:
a display screen;
an input device for operating the computing device and entering user responses;
a processor for executing programming that provides a user interface to the spreadsheet application wherein the user interface further comprises:
a display area on the display screen;
a spreadsheet area inside the display area, and
wherein definitions and results defined in the display area outside the spreadsheet area are available in the spreadsheet, and the spread sheet provides definitions and results defined in the spreadsheet to the display area outside and subsequent to the spreadsheet.

11. The handheld computing device of claim 10, wherein the spreadsheet area is a fully functional spreadsheet such that when a cursor is placed in the spreadsheet area, the full features of the spreadsheet are functional.

12. The handheld computing device of claim 10, wherein the display area is a computing display area of an interactive calculation environment.

13. The handheld computing device claim 10, further comprising application-based calculation environment wherein the spreadsheet and other portions of the software output appear as separate display screens.

14. The handheld computing device of claim 13, wherein the application-based calculation environment embodiment is on a handheld calculator.

15. The handheld computing device claim 10, wherein the display area is a computing display area of a calculation environment.

16. The handheld computing device claim 10, wherein the display area is part of a compound document which incorporates the spreadsheet and wherein the definitions and results outside the spreadsheet comprise math boxes and graphically displayed data.

17. The handheld computing device of claim 13, wherein the spreadsheet incorporates a separate math engine and library.

18. The handheld computing device of claim 15, wherein the spreadsheet incorporates a separate math engine and library.

19. The handheld computing device of claim 16, wherein the spreadsheet incorporates a separate math engine and library.

20. A software program stored on a computer media for a handheld computer device which provides a user interface comprising:
a display area;
a spreadsheet area inside the display area,
an application-based calculation environment wherein the spreadsheet and other portions of the software output appear on separate display screens, and
wherein definitions and results defined in the display area outside the spreadsheet area are available in the spreadsheet, and the spread sheet provides definitions and results defined in the spreadsheet to the display area outside and subsequent to the spreadsheet and.
